(19) United States
(12) Patent Application Publication
(10) Pub. No.: US 2014/0354797 A1
(43) Pub. Date: Dec. 4, 2014

(54) CALIBRATION BLOCK FOR MEASURING WARPAGE, WARPAGE MEASURING APPARATUS USING THE SAME, AND METHOD THEREOF

(71) Applicant: SAMSUNG ELECTRO-MECHANICS CO., LTD., Suwon-si (KR)

(72) Inventors: Seung Wan Woo, Suwon-si (KR); Ju Wan Nam, Suwon-si (KR); Young Nam Hwang, Suwon-si (KR); Kyung Ho Lee, Suwon-si (KR); Suk Jin Ham, Suwon-si (KR)

(73) Assignee: SAMSUNG ELECTRO-MECHANICS CO., LTD., Suwon-si (KR)

(21) Appl. No.: 14/182,186

(22) Filed: Feb. 17, 2014

(30) Foreign Application Priority Data
Jun. 4, 2013 (KR) 10-2013-0064177

(51) Int. Cl. G06T 7/00; G01B 11/25

(52) U.S. Cl. CPC G06T 7/0004; G01B 11/2504; G01B 11/254; G01B 2210/56
USPC 348/87; 73/1.79

(57) ABSTRACT

Disclosed herein are a calibration block for measuring warpage, a warpage measuring apparatus using the same, and a method thereof. The calibration block includes a substrate having one planar surface; and a stepped part forming a step at the center of the other surface of the substrate.

### CROSS REFERENCE TO RELATED APPLICATION

This application claims the benefit of Korean Patent Application No. 10-2013-0064177, filed on Jun. 4, 2013, entitled “Calibration block for measuring warpage, Warpage measuring apparatus using thereof and method thereof”, which is hereby incorporated by reference in its entirety into this application.

### BACKGROUND OF THE INVENTION

1. Technical Field

The present invention relates to a calibration block for measuring warpage, a warpage measuring apparatus using the same, and a method thereof.

2. Description of the Related Art

Recently, as electronic devices become smaller and thinner, warpage of a substrate becomes an important consideration.

At a level of packaging a product, influences caused by warpage of a substrate in processing or in use under high temperature have to be evaluated in advance, and methods and apparatuses for evaluating such influences are under development.

Recently, shadow moiré techniques are commonly used for measuring warpage of a substrate, in which a transparent quartz reference grating is placed on a target sample, a beam of light is directed from a light source thereto, a fringe image created on the surface of an object through the reference grating is observed by a CCD camera, and warpage is calculated through image processing.

Here, according to the principle of the shadow moiré measurement, particles of light are incident on the CCD camera vertically located, only when the light incident at a certain angle is diffusely reflected on the surface of the sample.

If the light is specularly reflected, incident and reflective angles are the same so that no light is incident on the camera vertically positioned.

Therefore, in order to measure warpage using the shadow moiré techniques, it is essential to pre-process a sample in order to make the surface of the sample diffusely reflective. Typically, such a pre-process is performed by thinly applying a white spray on the surface of the sample.

Calibration of a warpage measuring apparatus has to be conducted not only after setting up the apparatus but also periodically, for accurate measurements. In calibrating the apparatus, a calibration block by which an accurate step difference is obtained or convex/concave lens of which curvature is known are commonly used for determining whether warpage value measured by an actual apparatus is accurate.

The above method of using a quadrangular block having a stair-like step is conducted in a such manner that a block of which a step difference is already obtained through a precise process is measured, and the difference between the maximum value and the minimum value is calculated so to see if an actually known step difference is obtained. In the above method, however, it is difficult to analyze data after measurement since it is not suitable for the principle of the moiré measurement that “the difference between the average value of four edges and the central value” equals to warpage value.

The other method of using convex lens is conducted in a such manner that warpage of the convex lens is measure so as to see if a curvature in the actual specification is obtained. However, in measuring the warpage, warpage is analyzed on an area of interest cropped from the entire measured screen such that two points at upper-left and lower-right are designated for cropping in a quadrangular shape.

At this time, it is very difficult to crop a convex lens, so that it may not be accurately cropped and thus a warpage value changes accordingly.

Moreover, since the lens is transparent, it is necessary to apply a white spray thereon in order to make it diffusely reflective. However, it is almost impossible to evenly apply the white spray thereon, and thus the surface becomes rough which also influences the warpage value. Accordingly, it is difficult to accurately measure warpage.

### RELATED ART DOCUMENT

### Patent Document

(Patent Document 1) Japanese Patent Laid-Open Publication No. 2012-189479

### SUMMARY OF THE INVENTION

The present invention has been made in an effort to provide a calibration block for measuring warpage in which a step difference is present between its edges and center, a warpage measuring apparatus using the same, and a method thereof.

According to a first preferred embodiment of the present invention, there is provided a calibration block including a substrate having one planar surface; and a stepped part forming a step at the center of the other surface of the substrate.

The substrate may be a quadrangular plate.

The stepped part may have a concaved shape at the center of the other surface of the substrate.

The stepped part may have a height from the one surface of the substrate that is gradually lowered toward the center.

The stepped part may have a height from the one surface of the substrate that is gradually heightened toward the center.

The stepped part may have a convexed shape at the center of the other surface of the substrate.

The stepped part may have a height from the one surface of the substrate that is gradually heightened toward the center.

The stepped part may have a height from the one surface of the substrate that is gradually lowered toward the center.

The substrate may be a quadrangular plate, and the stepped part may have a step traversing from one side to the other side at the center of the other surface of the substrate.

The stepped part may have a concaved shape at the center of the other surface of the substrate.

The stepped part may have a height from the one surface of the substrate that is gradually lowered toward the center.

The stepped part may have a height from the one surface of the substrate that is gradually heightened toward the center.

The stepped part may have a convexed shape at the center of the other surface of the substrate.

The stepped part may have a height from the one surface of the substrate that is gradually heightened toward the center.

The stepped part may have a height from the one surface of the substrate that is gradually lowered toward the center.

The calibration block may further include a reflective pattern part diffusely reflecting incident light forwardly on the other surface of the substrate.

The reflective pattern part may be a sand finish part formed by performing a sand finish process on its surface.

The reflective pattern part may be a matt finish part formed by performing a matt finish process on its surface.

According to a second preferred embodiment of the present invention, there is provided a warpage measuring apparatus, including: a projection unit projecting grating pattern illumination on a sample; an image formation unit imaging an image of the grating pattern reflected on the sample, and a control unit measuring warpage using the image of the grating pattern imaged by the image formation unit, wherein the control unit, when a calibration block including a substrate having one planar surface, and a stepped part forming a step at the center of the other surface of the substrate as the sample, measures warpage of the calibration block to compare it with a reference warpage value of the calibration block, and stores a difference therebetween to reflect it in measuring warpage of the sample.

The stepped part may have a concaved shape at the center of the other surface of the substrate.

The stepped part may have a concaved shape at the center of the other surface of the substrate.

The substrate may be a quadrangular plate, and the stepped part may have a step traversing from one side to the other side at the center of the other surface of the substrate.

The calibration block may further include a reflective pattern part diffusely reflecting incident light forwardly on the other surface of the substrate.

According to a third preferred embodiment of the present invention, there is provided a method for measuring warpage, including: (A) installing in a support frame a calibration block including a substrate having one planar surface, and a stepped part forming a step at the center of the other surface of the substrate; (B) controlling, by a control unit, a projection unit and an image formation unit so that grating pattern illumination is projected onto the calibration block and an image of grating pattern reflected on the calibration block is imaged; (C) calculating, by the control unit, a calibration value using the imaged grating pattern to obtain a warpage value; and (D) measuring, by the control unit, warpage value by reflecting the calibration value in measuring warpage of a sample, to output a value.

The step of (B) may include: (B-1) controlling, by the control unit, the projection unit so that grating pattern illumination is projected onto the calibration block installed in the support frame; and (B-2) controlling, by the control unit, the image formation unit so that grating pattern image reflected on the calibration block is image.

The step of (C) may include: (C-1) calculating, by the control unit, the warpage value using the grating pattern image imaged by the image formation unit; (C-2) comparing, by the control unit, the calculated warpage value with a reference warpage value set for the calibration block; and (C-3) if, there is a difference therebetween, storing, by the control unit, the difference as the calibration value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a calibration block for measuring warpage according to a first preferred embodiment of the present invention;

FIG. 2 is a front view of the calibration block shown in FIG. 1;

FIG. 3 is a plan view of the calibration block shown in FIG. 1;

FIGS. 4A and 4B are views showing examples of a reflective pattern of a reflective pattern part;

FIG. 5 is a perspective view of a calibration block for measuring warpage according to a second preferred embodiment of the present invention;

FIG. 6 is a front view of the calibration block shown in FIG. 5;

FIG. 7 is a plan view of the calibration block shown in FIG. 5;

FIG. 8 is a perspective view of a calibration block for measuring warpage according to a third preferred embodiment of the present invention;

FIG. 9 is a front view of the calibration block shown in FIG. 8;

FIG. 10 is a plan view of the calibration block shown in FIG. 8;

FIG. 11 is a perspective view of a calibration block for measuring warpage according to a fourth preferred embodiment of the present invention;

FIG. 12 is a front view of the calibration block shown in FIG. 11;

FIG. 13 is a plan view of the calibration block shown in FIG. 11;

FIG. 14 is a block diagram illustrating the configuration of a warpage measuring apparatus using a calibration block for measuring warpage according to the present invention; and

FIG. 15 is a flow chart block illustrating a method for measuring warpage using a calibration block for measuring warpage according to the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

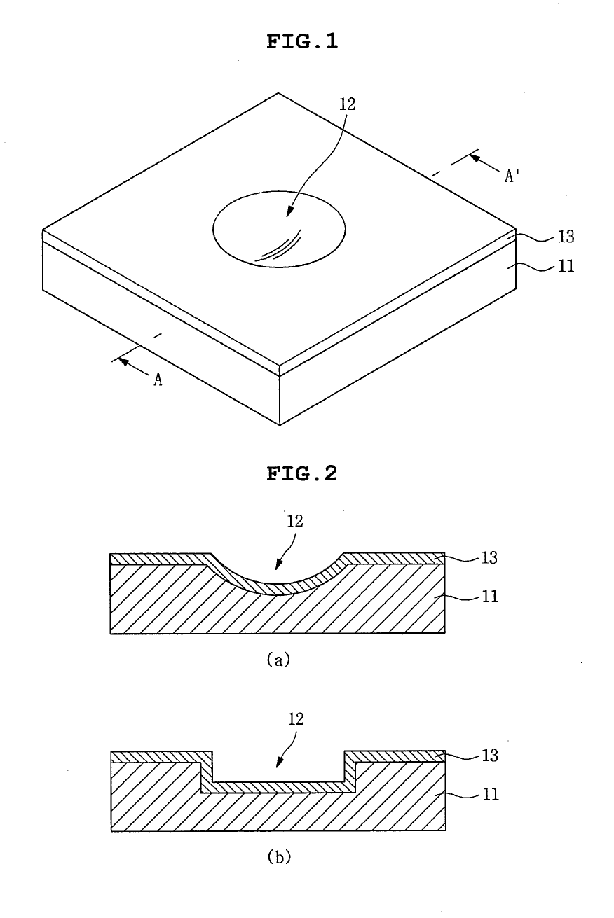

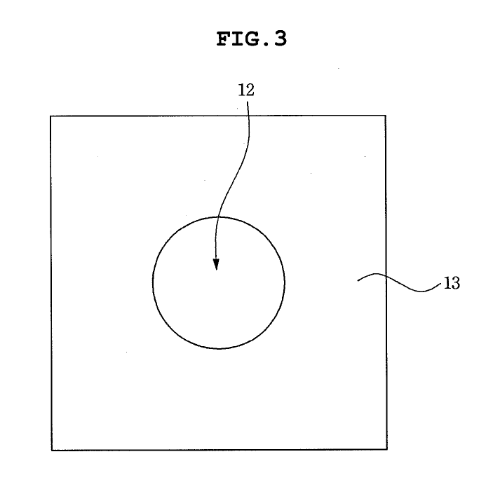

FIG. 1 is a perspective view of a calibration block for measuring warpage according to a first preferred embodiment of the present invention; FIGS. 2A and 2B are side views taken along line A-A′ of FIG. 1; and FIG. 3 is a plan view of the calibration block of FIG. 1.

Referring to FIGS. 1 to 3, the calibration block for measuring warpage according to the first preferred embodiment includes a substrate 11 having a planar surface, and a stepped part 12 forming a step at the center of the other surface of the substrate 11. Further, the calibration block includes a reflective pattern part 13.

The substrate 11 is formed as a quadrangular plate, preferably, a square plate.

As is appreciated, the shape of the substrate 11 is not limited thereto but has various shapes as long as it has a symmetric structure with respect to an axis.

As an example, the substrate 11 may be a circular plate or a hexagonal plate having a symmetric structure with respect to an axis.

The material of the substrate 11 is not specifically limited but may be made of a plastic material or a metal material. In order to make a diffused reflective surface, the material of the substrate is preferably metal, more preferably aluminum.

The dimensions of the substrate 11 may vary depending on the specification of a warpage measuring apparatus, for example, a width of 60 to 100 mm and a length 60 to 100 mm, preferably, a width of 80 mm and a length of 80 mm.

The thickness of the substrate 11 may vary depending on the specification of a warpage measuring apparatus, for example 10 mm.

One surface, especially a bottom surface of the substrate 11 is planar so that measuring for calibration may be stably conducted.

The stepped part 12 is formed on the top surface of the substrate 11, and has a concave shape. The stepped part 12 is formed at the center of the substrate 11.

Preferably, the stepped part 12 is formed at the center of the substrate 11 and has a circular shape; however, the stepped part is not limited thereto but may have various shapes such as quadrangular, pentagonal, hexagonal shapes and so on.

As shown in FIG. 2A, the stepped part 12 may have a shape that is gradually lowered toward the center from the edge so as to obtain a moiré shape. The difference of heights between the center of the stepped part 12 and the surface may be, for example, 800 to 1200 μm, preferably 1000 μm.

However, the shape of the stepped part 12 is not limited thereto but may be a stair-like shape having a planar recess surface, as shown in FIG. 2B.

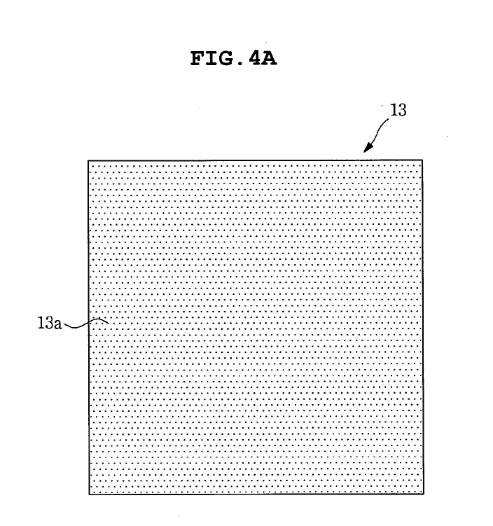

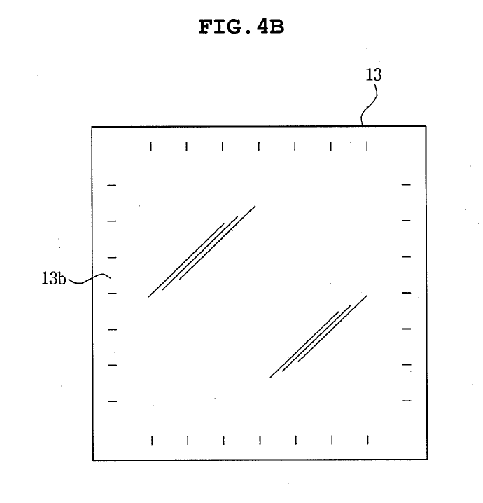

Further, the reflective pattern part 13 has a reflective pattern on its upper surface for enhancing brightness. The reflective pattern may be a sand finish part 13a formed by performing a sand finish process on the surface as shown in FIG. 4A, or may be a matt finish part 13b formed by performing a matt finish process on the surface.

The thickness of the pattern part 13 may be 5 to 30 μm, preferably 15 μm.

The reflective pattern part 13 diffusely reflects incident light forwardly so as to maximize the enhancement of brightness.

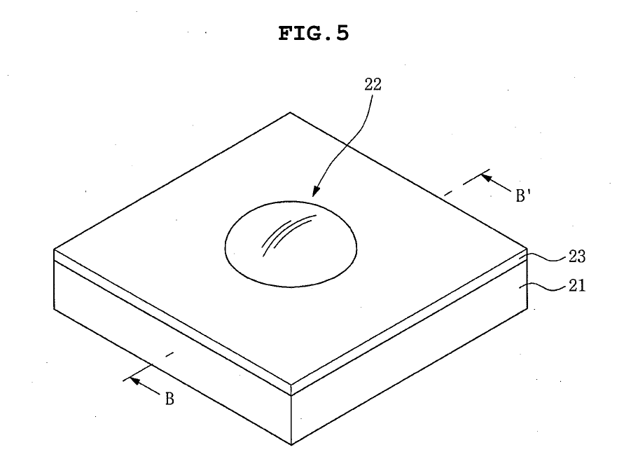

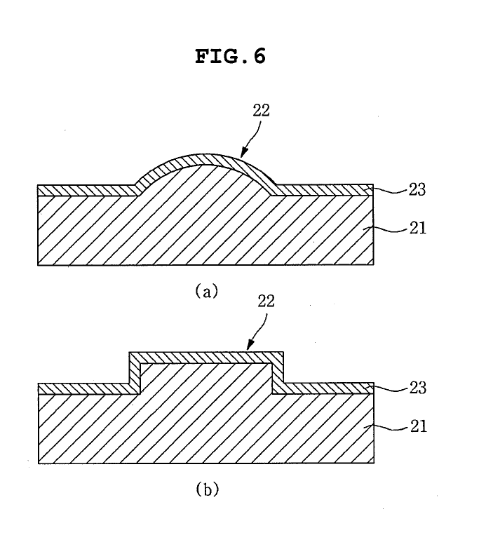

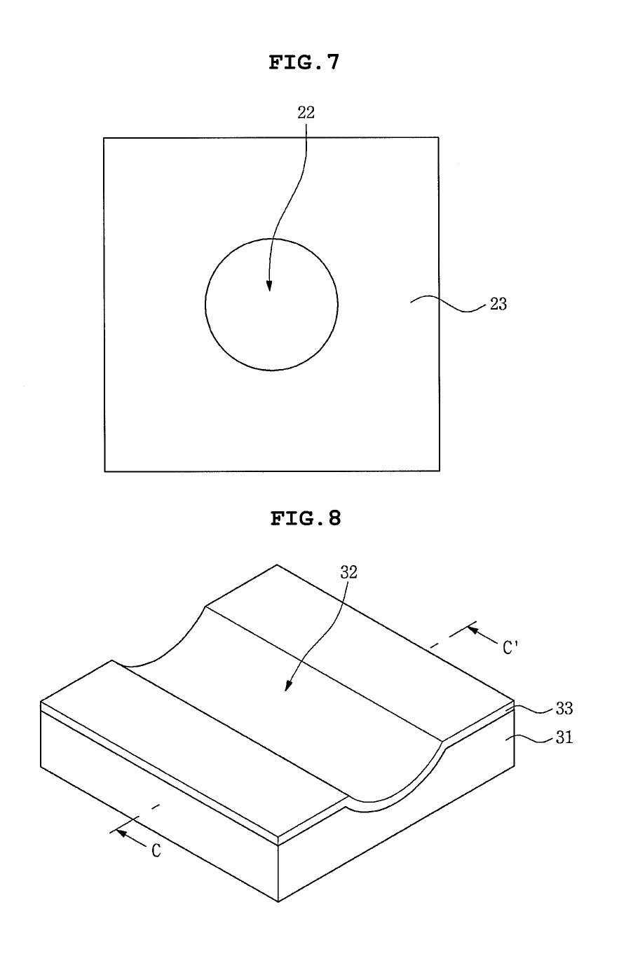

FIG. 5 is a perspective view of a calibration block for measuring warpage according to a second preferred embodiment of the present invention; FIGS. 6A and 6B are side views taken along line B-B′ of FIG. 5; and FIG. 7 is a plan view of the calibration block of FIG. 5.

Referring to FIGS. 5 to 7, the calibration block for measuring warpage according to the second preferred embodiment includes a substrate 21 having a planar surface, and a stepped part 22 forming a step at the center of the other surface of the substrate 21. Further, the calibration block includes a reflective pattern part 23.

The calibration block according to the another embodiment of the present invention is identical to the calibration block shown in FIGS. 1 to 4 except for the shape of the stepped part 22; and, therefore, a description on the identical elements will be omitted and the stepped part 22 will be described below.

The stepped part 22 is formed on the top surface of the substrate 21, and has a convexed shape. The stepped part 22 is formed at the center of the substrate 21.

Preferably, the stepped part 22 is formed at the center of the substrate 21 and has a circular shape; however, the stepped part is not limited thereto but may have various shapes such as quadrangular, pentagonal, hexagonal shapes and so on.

As shown in FIG. 6A, the stepped part 22 may have a shape that is gradually heightened toward the center from the edge so as to obtain a moiré shape.

However, the shape of the stepped part 22 is not limited thereto but may be a stair-like shape having a planar protrusion surface, as shown in FIG. 6B.

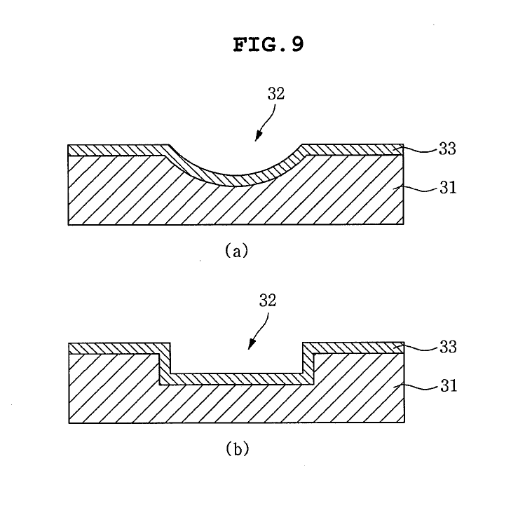

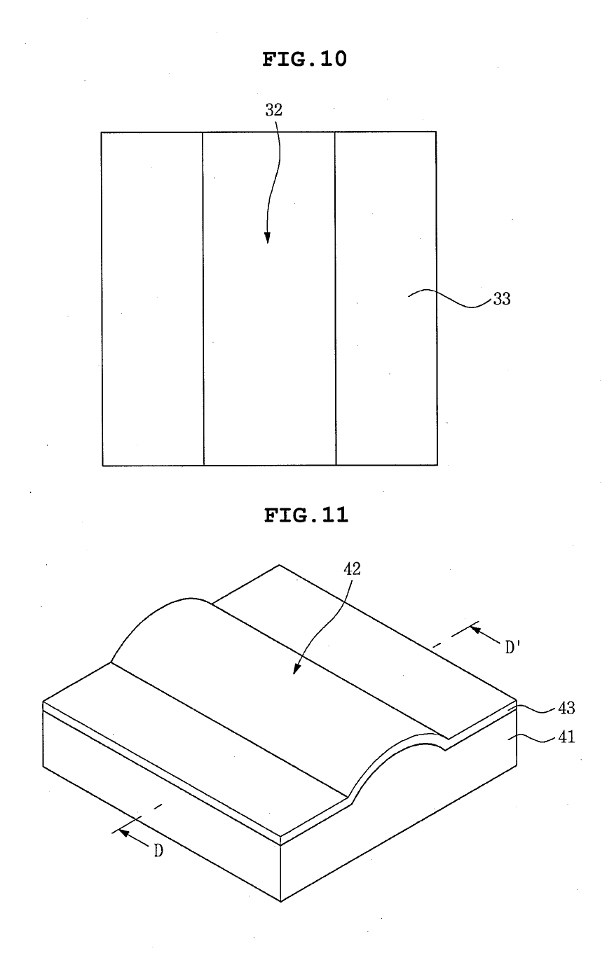

FIG. 8 is a perspective view of a calibration block for measuring warpage according to a third preferred embodiment of the present invention; FIGS. 9A and 9B are side views taken along line C-C′ of FIG. 8; and FIG. 10 is a plan view of the calibration block of FIG. 8.

Referring to FIGS. 8 to 10, the calibration block for measuring warpage according to the third preferred embodiment includes a substrate 31 having a planar surface, and a stepped part 32 traversing from one side to the other side of the other surface of the substrate 31 and forming a step. Further, the calibration block includes a reflective pattern part 33.

The substrate 31 is formed as a quadrangular plate, preferably, a square plate.

As is appreciated, the shape of the substrate 31 is not limited thereto but has various shapes as long as it has a symmetric structure with respect to an axis.

The material of the substrate 31 is not specifically limited but may be made of a plastic material or a metal material. In order to make a diffused reflective surface, the material of the substrate is preferably metal, more preferably aluminum.

The dimensions of the substrate 31 may vary depending on the specification of a warpage measuring apparatus, for example, a width of 60 to 100 mm and a length 60 to 100 mm, preferably, a width of 80 mm and a length of 80 mm.

The thickness of the substrate 31 may vary depending on the specification of a warpage measuring apparatus, for example 10 mm.

One surface, especially a bottom surface of the substrate 31 is planar so that measuring for calibration may be stably conducted.

The stepped part 32 is formed on the top surface of the substrate 31, traverses from one side to the other side thereof, and has a concaved shape. The stepped part 12 is formed at the center of the substrate 31.

Preferably, the stepped part 32 traverses from one side to the other side of the substrate 31 with the same width.

As shown in FIG. 9A, the stepped part 32 may have a shape that is gradually lowered toward the center from the edge so as to obtain a moiré shape. The difference of heights between the center of the stepped part 32 and the surface may be, for example, 800 to 1200 μm, preferably 1000 μm.

However, the shape of the stepped part 32 is not limited thereto but may be a stair-like shape having a planar recess surface, as shown in FIG. 9B.

Further, the reflective pattern part 33 has a reflective pattern on its upper surface for enhancing brightness. The reflective pattern may be a sand finish part 13a formed by performing a sand finish process on the surface as shown in FIG. 4A, or may be a matt finish part 13b formed by performing a matt finish process on the surface.

The reflective pattern part 33 diffusely reflects incident light forwardly so as to maximize the enhancement of brightness.

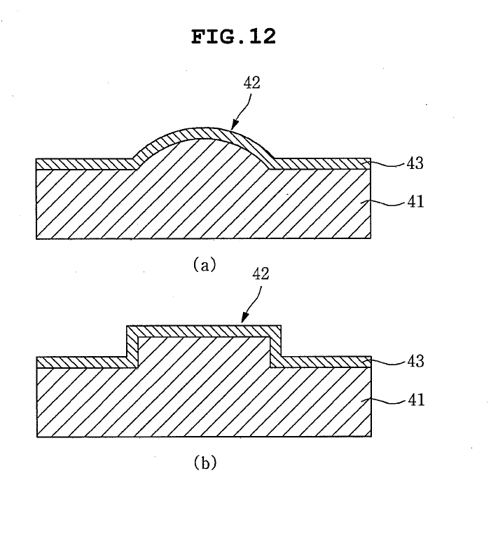

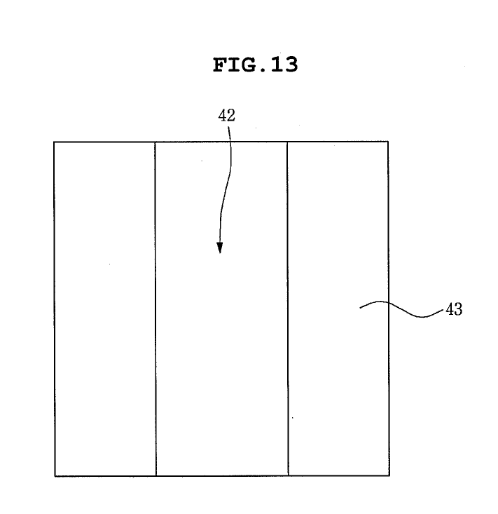

FIG. 11 is a perspective view of a calibration block for measuring warpage according to a fourth preferred embodiment of the present invention; FIGS. 12A and 12B are side views taken along line D-D′ of FIG. 11; and FIG. 13 is a plan view of the calibration block of FIG. 11.

Referring to FIGS. 11 to 13, the calibration block for measuring warpage according to the fourth preferred embodiment includes a substrate 41 having a planar surface, and a stepped part 42 forming a step at the center of the other surface of the substrate 41. Further, the calibration block includes a reflective pattern part 43.

The calibration block according to the another embodiment of the present invention is identical to the calibration block shown in FIGS. 8 to 10 except for the shape of the stepped part 42; and, therefore, description on the identical elements will be omitted and the stepped part 42 will be described below.

The stepped part 42 is formed on the top surface of the substrate 41, traverses from one side to the other side, and has a convexed shape for forming a step. The stepped part 12 is formed at the center of the substrate 42.

Preferably, the stepped part 42 traverses from one side to the other side of the substrate 41 with the same width, but the width may be variable.

As shown in FIG. 12A, the stepped part 42 may have a shape that is gradually heightened toward the center from the edge so as to obtain a moiré shape.

However, the shape of the stepped part 42 is not limited thereto but may be a stair-like shape having a planar protrusion surface, as shown in FIG. 12B.

According to the present invention, manufacturing a calibration block by performing a sand finish and a matt finish eliminates the need of applying a white spray, such that a step difference can be accurately measured.

That is, according to the principle of shadow moiré measurement, a white spray is applied onto the surface of a sample in the prior art, in order to make the surface diffusely reflective. Applying a white spray onto a calibration block, which requires an accurate step, influences a warpage value. In contrast, according to the present invention, manufacturing a calibration block by performing a sand finish and a matt finish eliminates the need of applying a white spray, such that a step difference can be accurately measured.

Further, according to the present invention, by manufacturing a calibration block well conforming to the principle of shadow moiré measurement, i.e., a warpage value equals to “the difference between the average value of four edges and the central value,” calibration may be accurately conducted.

Further, according to the present invention, by manufacturing a quadrangular block having three types of steps, cropping may be conducted through auto edge detecting, and thereby an accurate warpage value may be obtained.

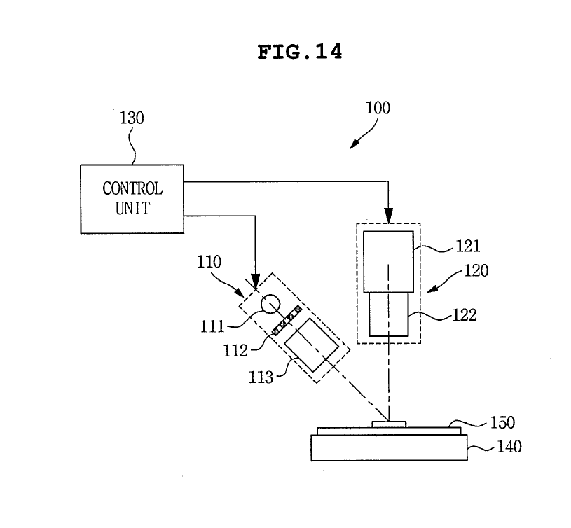

FIG. 14 is a block diagram illustrating the configuration of a warpage measuring apparatus using a calibration block for measuring warpage according to the present invention.

Referring to FIG. 14, the warpage measuring apparatus using the calibration block for measuring warpage according to the present invention includes a projection unit 110, an image formation unit 120, a control unit 130, and a support frame 140.

The projection unit 110 projects a grating pattern illumination onto a sample 150 fixed on the support frame 140. The projection unit 110 may be placed to emit the grating pattern illumination at a certain angle to the normal line of the sample 150.

Further, the projection unit 110 includes an illumination source 111 and a grating element 112. In addition, the projection unit 110 may further include a projection lens unit 113. The illumination source 111 emits light toward the sample 150. The grating element 112 converts the light emitted from the illumination source into grating pattern light conforming to a grating pattern.

The projection lens unit 113 projects the grating pattern light generated by the grating element 112 onto the sample 150. The projection lens unit 113 may consist of, for example, a combination of lenses, and focuses the grating pattern light generated by the grating element 112 on the sample 150.

The image formation unit 120 images a grating pattern image reflected on the sample 150 by the grating pattern light projected onto the sample 150.

The image formation unit 120 may include a camera 121 and an image formation lens unit 122 for imaging the grating pattern image. The camera may include a CCD or CMOS camera.

Accordingly, the grating pattern image reflected on the sample 150 passes through the image formation lens unit 122 and then imaged by the camera 121.

The control unit 130 controls overall operations of components included in the warpage measuring apparatus. The control unit 130 controls the projection unit 110 so that it uses the grating element 112 to emit the grating pattern light onto the sample 150.

Further, the control unit 130 controls the image formation unit 120 so that it images the grating pattern image reflected on the sample 150.

The control unit 130 uses the grating pattern image imaged by the image formation unit 120 to measure warpage based on shadow moiré method.

The shadow moiré is a measurement technique using interference between a grating element 112 and the shadow of the grating element 112 created on a sample 150. Specifically, a grating element 112 having equally spaced parallel lines is placed directly in front of a target object, and a beam of light is directed from a side so that shadow of the grating is created on the target object. The shadow has warpage conforming to the shape of the target object.

When the target object is seen from the other side, grating having undeformed parallel lines and the shadow of the grating are superposed, so that an image of grating shape having a wave-like contour, a so-called moiré pattern is seen. This contains shape information so that a height value is obtained by analyzing it.

Such a warpage measuring apparatus using the shadow moiré has an error in a measured height value depending on the positions of the projection unit 110 and the image forming unit 120. Therefore, it is essential to conduct calibration on the apparatus periodically.

To this end, according to the present invention, the calibration block shown in any one of FIGS. 1 to 13 is installed in the support frame 140, and warpage of the calibration block is measured by controlling the projection unit 110 and the image formation unit 120 using the control unit 130.

Here, the control unit 130 calculates the average value of four edges C1 to C4 measured by the image formation unit 120, and subtract the center value C0 at the center from the average value, to obtain warpage value.

Then, the control unit 130 compares the obtained value with the reference warpage value set when the calibration block is manufactured, and if the obtained warpage value is different from the reference warpage value, the difference is stored as a calibration value and reflected when warpage of a sample is measured afterward, so as to output a value reflecting the same. As described so far, with the help of the calibration, measurement can be accurately conducted.

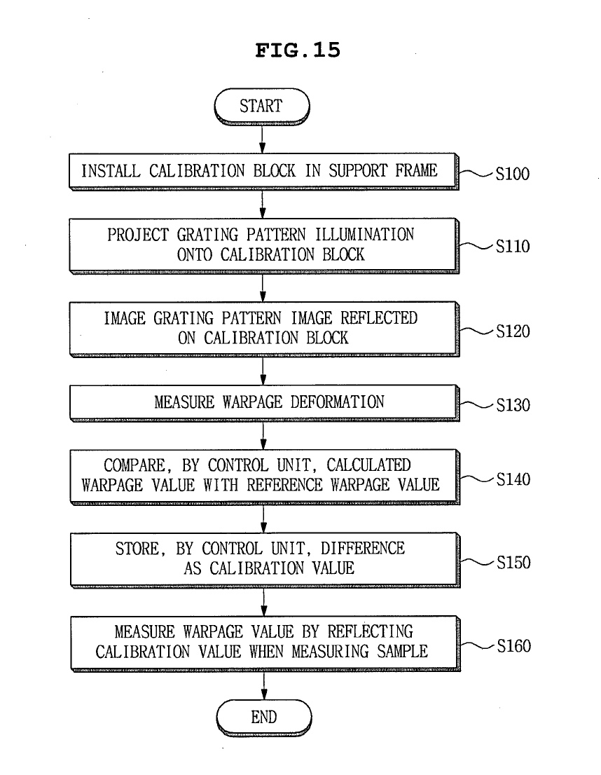

FIG. 15 is a flow chart illustrating a method for measuring warpage using a calibration block according to an embodiment of the present invention. The method starts with installing a calibration block shown in any one of FIGS. 1 to 13 in a support frame (S100).

Then, a control unit controls a projection unit so that grating pattern illumination is projected onto the calibration block installed in the support frame (S110). Here, the projection unit projects the grating pattern illumination at a certain angle to the normal line of a sample.

Then, the control unit controls an image formation unit so that grating pattern image reflected on the calibration block (S120).

Then, the control unit uses the grating pattern image imaged by the image formation unit to measure warpage deformation based on a shadow moiré method (S130).

Here, the control unit calculates the average value of four edges C1 to C4 measured by the image formation unit, and subtract the center value C0 at the center from the average value, to obtain the warpage value.

Then, the control unit compares the obtained warpage value with the reference warpage value already set when the calibration block is manufactured (S140).

If there is a difference therebetween, the control unit 140 stores the difference as a calibration value (S150), and reflects the same when measuring warpage of a sample, to output a value reflecting the same (S160). As described so far, with the help of the calibration, measurement can be accurately conducted.

According to the present invention, manufacturing of a calibration block by performing a sand finish and a matt finish eliminates the need of applying a white spray, such that a step difference can be accurately measured.

That is, according to the principle of shadow moiré measurement, a white spray is applied onto the surface of a sample in the prior art, in order to make the surface diffusely reflective. Applying a white spray onto a calibration block, which requires an accurate step, influences a warpage value. In contrast, according to the present invention, manufacturing a calibration block by performing a sand finish and a matt finish eliminates the need of applying a white spray, such that a step difference can be accurately measured.

Further, according to the present invention, by manufacturing a calibration block well conforming to the principle of shadow moiré measurement, i.e., a warpage value equals to “the difference between the average value of four edges and the central value,” calibration may be accurately conducted.

Further, according to the present invention, by manufacturing a quadrangular block having three types of steps, cropping may be conducted through auto edge detecting, and thereby an accurate warpage value may be obtained.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A calibration block for measuring warpage, comprising:
a substrate having one planar surface; and
a stepped part forming a step at the center of the other surface of the substrate.

2. The calibration block as set forth in claim 1, wherein the substrate is a quadrangular plate.

3. The calibration block as set forth in claim 1, wherein the stepped part has a concaved shape at the center of the other surface of the substrate.

4. The calibration block as set forth in claim 3, wherein the stepped part has a height from the one surface of the substrate that is gradually lowered toward the center.

5. The calibration block as set forth in claim 3, wherein the stepped part has a height from the one surface of the substrate that is lowered in a stair-like manner.

6. The calibration block as set forth in claim 1, wherein the stepped part has a convexed shape at the center of the other surface of the substrate.

7. The calibration block as set forth in claim 6, wherein the stepped part has a height from the one surface of the substrate that is gradually heightened toward the center.

8. The calibration block as set forth in claim 6, wherein the stepped part has a height from the one surface of the substrate that is heightened in a stair-like manner.

9. The calibration block as set forth in claim 1, wherein the substrate is a quadrangular plate, and wherein the stepped part has a step traversing from one side to the other side at the center of the other surface of the substrate.

10. The calibration block as set forth in claim 9, wherein the stepped part has a concaved shape at the center of the other surface of the substrate.

11. The calibration block as set forth in claim 10, wherein the stepped part has a height from the one surface of the substrate that is gradually lowered toward the center.

12. The calibration block as set forth in claim 10, wherein the stepped part has a height from the one surface of the substrate that is lowered in a stair-like manner.

13. The calibration block as set forth in claim 9, wherein the stepped part has a convexed shape at the center of the other surface of the substrate.

14. The calibration block as set forth in claim 13, wherein the stepped part has a height from the one surface of the substrate that is gradually heightened toward the center.

15. The calibration block as set forth in claim 13, wherein the stepped part has a height from the one surface of the substrate that is heightened in a stair-like manner.

16. The calibration block as set forth in claim 1, further comprising a reflective pattern part diffusely reflecting incident light forwardly on the other surface of the substrate.

17. The calibration block as set forth in claim 16, wherein the reflective pattern part is a sand finish part formed by performing a sand finish process on its surface.

18. The calibration block as set forth in claim 17, wherein the reflective pattern part is a matt finish part formed by performing a matt finish process on its surface.

19. A warpage measuring apparatus, comprising:
a projection unit projecting grating pattern illumination on a sample;
an image formation unit imaging an image of the grating pattern reflected on the sample; and
a control unit measuring warpage using the image of the grating pattern imaged by the image formation unit,
wherein the control unit, when a calibration block including a substrate having one planar surface, and a stepped part forming a step at the center of the other surface of the substrate is used as the sample, measures warpage of the calibration block to compare it with a reference warpage value of the calibration block, and stores a difference therebetween to reflect it in measuring warpage of the sample.

20. The apparatus as set forth in claim 19, wherein the stepped part has a concaved shape at the center of the other surface of the substrate.

21. The apparatus as set forth in claim 19, wherein the stepped part has a convexed shape at the center of the other surface of the substrate.

22. The apparatus as set forth in claim 19, wherein the substrate is a quadrangular plate, and wherein the stepped part has a step traversing from one side to the other side at the center of the other surface of the substrate.

23. The apparatus as set forth in claim 19, wherein the calibration block further includes a reflective pattern part diffusely reflecting incident light forwardly on the other surface of the substrate.

24. A method for measuring warpage, comprising:
(A) installing in a support frame a calibration block including a substrate having one planar surface, and a stepped part forming a step at the center of the other surface of the substrate;
(B) controlling, by a control unit, a projection unit and an image formation unit so that grating pattern illumination is projected onto the calibration block and an image of grating pattern reflected on the calibration block is imaged;
(C) calculating, by the control unit, a calibration value using the imaged grating pattern to obtain a warpage value; and
(D) measuring, by the control unit, warpage value by reflecting the calibration value in measuring warpage of a sample, to output a value.

25. The method as set forth in claim 24, wherein (B) includes:
(B-1) controlling, by the control unit, the projection unit so that grating pattern illumination is projected onto the calibration block installed in the support frame; and
(B-2) controlling, by the control unit, the image formation unit so that grating pattern image reflected on the calibration block is image.

26. The method as set forth in claim 24, wherein (C) includes:
(C-1) calculating, by the control unit, the warpage value using the grating pattern image imaged by the image formation unit;
(C-2) comparing, by the control unit, the calculated warpage value with a reference warpage value set for the calibration block; and
(C-3) if there is a difference therebetween, storing, by the control unit, the difference as the calibration value.
